(19) United States
(12) Patent Application Publication
(10) Pub. No.: US 2012/0224204 A1
(43) Pub. Date: Sep. 6, 2012

(54) PRINTING MANAGEMENT DEVICE, PRINTING MANAGEMENT METHOD, PRINTING SYSTEM AND RECORDING MEDIUM

(75) Inventor: Miki Yamagishi, Tokyo (JP)

(73) Assignee: RICOH COMPANY, LTD., Tokyo (JP)

(21) Appl. No.: 13/371,845

(22) Filed: Feb. 13, 2012

(30) Foreign Application Priority Data
Mar. 2, 2011 (JP) 2011-045637

(51) Int. Cl. G06K 15/02

(52) U.S. Cl. 358/1.13

(57) ABSTRACT

A disclosed non-transitory computer-readable recording medium includes a printing management program. The printing management program, when processed by a processor, causes a computer to function as a registration receiving unit configured to receive registration of a sheet requirement of first sheets that is specified in a print job, a print job receiving unit configured to receive the print job from a previous process within a printing process, and a print preview display unit configured to reflect the registered sheet requirement of the first sheets in the received print job to display a print preview.

### BACKGROUND OF THE INVENTION

1. Field of the Invention

The disclosures discussed herein generally relate to a printing management device, a printing management method, a printing system and a computer-readable recording medium storing a printing management program.

2. Description of the Related Art

The commercial printing business refers to a particular area of work that makes a profit by generating a printout product requested from a customer based on printed matter (e.g., a catalog, an advertisement) received from the customer, and delivering the generated printout product to the customer. Such a commercial printing business involves plural processes from receiving of printed matter from the customer to delivering of the printout product to the customer. More specifically, the plural processes from receiving of printed matter to delivering of the printout product includes a prepress task including receiving printed matter of a manuscript from the customer, receiving a printing requirement for the printout product, correcting colors, correcting a layout, correcting a binding position and the like, and a postpress task including printing a proof-reading printout for the customer to proofread a result of the prepress task, printing and subsequently binding to prepare the printout product, delivering the printout product to the customer and the like. Note that the number of processes from receiving of printed matter to delivering of the printout product may vary with the printing requirement for the printout product requested by the customer.

In the typical commercial printing business, a large number of orders are associated with mass-production of printout products, and hence, such printout products are mass-produced in the aforementioned processes. Further, the printing requirement for the mass-production of the printout products requested by the customer is generally inflexible in most cases. Thus, the printout products desired by the customer are generated in a printing cycle of mass-producing the printout products based on a printing requirement, changing the printing requirement into another after having printed one lot of the printout products, and mass-producing printout products based on the changed printing requirement.

In this printing cycle, the aforementioned plural processes may need to be carried out frequently when the printing requirement is changed. However, when there is no change in the printing requirement, printing may be continued in one process, thereby effectively performing mass-producing task.

A so-called “print on demand” (POD) market has recently emerged in the commercial printing business. In the POD business, a relatively small lot of printing products is delivered to the customer in a short period. In the POD market, orders are placed from numerous different customers. As a result, printed matter received by the commercial printing company or printing products may have a wide variety of printing requirements in the POD market.

Further, along with a recent increase in digitization of printed matter, computers are utilized for controlling the generation of the printed matter or printout products. For example, there are proposed a technology of receiving the printed matter as electric data via a network and a technology of controlling a workflow of the aforementioned plural processes. For example, a printing operation in the aforementioned plural processes of the workflow is defined by a job ticket called a job definition format (JDF), and the printing operation is controlled based on the JDF in the printing system.

With a change in the above-described printing environment, the commercial printing companies have promoted the computerization of the printing system in order to generate the received orders of the printed matter. In addition, the commercial printing companies have been required to construct the printing system capable of satisfying a wide variety of the printing requirements for the printout products desired by the customers. Moreover, a system management, such as introducing plural printer devices and/or peripheral devices, or an operation process management, such as changing of the aforementioned plural processes in the relatively short cycle, may also be required in order to generate the printout products that satisfy the wide variety of the printing requirements desired by the customers.

For the commercial printing companies; however, it may be necessary to increase job efficiency further in order to make a profit despite the fact that the above managements are required. A technique for improving the job efficiency includes simplifying printing tasks.

For example, the commercial printing companies generally have a desire to preview output results of the printed matter or printout products prior to actually being printed by printing apparatuses. A print preview function is configured to display a printing form in order to allow a user of the commercial printing company to check such output results. High-speed machines (i.e., printer devices) utilized by the commercial printing companies include various binding forms associated with printing of print jobs and are configured to produce a large number of printouts. Thus, the high-speed machines are more highly required to display a print preview as similar to the actually printed product as possible compared to intermediate-speed or low-speed machines (printer devices).

For example, In the POD printing, there is disclosed in the art (e.g., Japanese Patent Application Laid-Open Publication No. 2002-103726, hereinafter also referred to as “Patent Document 1”) a printing system that includes a print preview function to sufficiently express the paper quality, such as smoothness, glossiness, transparency and color tone of paper.

As described above, the related art printing management device having a print preview function may be capable of displaying a print preview that reflects detailed characteristics of paper specified in each of print jobs. However, the print preview function of the related art printing management device does not reflect the characteristics of paper actually set in a paper feeder tray of the printer device.

Accordingly, the related art printing management device having the above preview function may display the print preview that reflects detailed characteristics of paper specified in each of print jobs; however, such detailed characteristics of the paper specified in the print job may not necessarily match the characteristics of paper actually set (placed) in the paper feeder tray of the printer device. However, the commercial printing companies may not always be successful in determining as to whether the characteristics reflected in the print preview matches the characteristics of the paper actually set in the paper feeder tray of the printer device. Hence, the output result of the printout product may not always match the print preview.

### SUMMARY OF THE INVENTION

It is a general object of at least one embodiment of the present invention to provide a printing management device, a printing management method, a printing system and computer-readable recording medium storing a printing management program, which substantially eliminates one or more problems caused by the limitations and disadvantages of the related art.

In one embodiment, there is provided a non-transitory computer-readable recording medium that includes a printing management program. The printing management program, when processed by a processor, causes a computer to function as: a registration receiving unit configured to receive registration of a sheet requirement of first sheets, the registered sheet requirement of the first sheets being specified in a print job; a print job receiving unit configured to receive the print job from a previous process within a printing process; and a print preview display unit configured to reflect the registered sheet requirement of the first sheets in the received print job to display a print preview.

Additional objects and advantages of the embodiments will be set forth in part in the description which follows, and in part will be obvious from the description, or may be learned by practice of the invention. It is to be understood that both the foregoing general description and the following detailed description are exemplary and explanatory only and are not restrictive of the invention, as claimed.

### BRIEF DESCRIPTION OF THE DRAWINGS

Other objects and further features of embodiments will be apparent from the following detailed description when read in conjunction with the accompanying drawings, in which:

FIG. 1 is a system configuration diagram illustrating an example of a system including a printing system to which an embodiment is applied;

FIG. 2 is a hardware configuration diagram illustrating an example of a personal computer (PC);

FIG. 3 is a process block diagram illustrating an example of a print server;

FIG. 4 is a configuration diagram illustrating an example of a print job table;

FIG. 5 is a configuration diagram illustrating an example of a print schedule table;

FIG. 6 is a configuration diagram illustrating an example of a tray-dependent sheet table;

FIG. 7 is a configuration diagram illustrating an example of a sheet-in-use table;

FIG. 8 is an image diagram illustrating an example of a print job information display screen;

FIG. 9 is an image diagram illustrating an example of a tray-dependent sheet information screen;

FIG. 10 is an image diagram illustrating an example of a sheet requirement registering screen;

FIG. 11 is a flowchart (1/3) illustrating an example of a printing procedure accompanied with a print preview display;

FIG. 12 is a flowchart (2/3) illustrating an example of the printing procedure accompanied with the print preview display;

FIG. 13 is a flowchart (3/3) illustrating an example of the printing procedure accompanied with the print preview display;

FIGS. 14A and 14B are image diagrams illustrating an example of a print preview screen;

FIG. 15 is an image diagram illustrating an example of an alert display screen indicating to an operator a difference between sheets set in a paper feed tray and sheets displayed in a print preview;

FIG. 16 is an image diagram illustrating an example of an alert display screen inviting the operator to check the paper feed tray to which sheets are to be supplied;

FIG. 17 is a data structure diagram illustrating an example of data of a printer device from which the printability (device capability) information is acquired;

FIG. 18 is a configuration diagram illustrating an example of settings of sheets of the print job; and

FIG. 19 is a configuration diagram illustrating an example of information on sheets in the paper feed trays acquired from the printer device.

### DESCRIPTION OF THE PREFERRED EMBODIMENTS

Next, Preferred embodiments are described below with reference to the accompanying drawings.

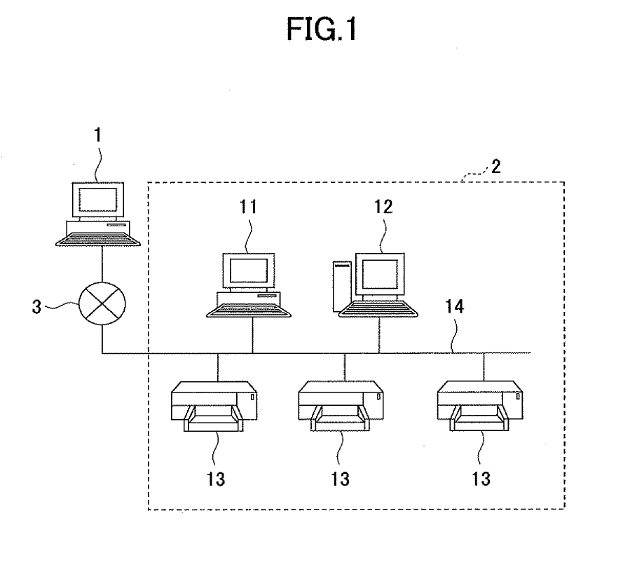

FIG. 1 is a system configuration diagram illustrating an example of a system including a printing system to which an embodiment is applied. The printing system in FIG. 1 includes a user client 1 and a printing system 2, which are connected via a network 3 such as the Internet. The user client 1 is a computer utilized by a customer when the customer outsources printing operations to a commercial printing company. The printing system 2 is a system utilized by a user (an operator) of the commercial printing company.

Further, the printing system 2 includes a management client 11, a print server 12, one or more printer devices 13 and a network 14 such as a LAN. The management client 11, the print server 12 and the printer devices 13 are connected via the network 14.

The customer sends a print job including a job ticket of print target documents and print data to the print server 12. The management client 11 is a computer utilized by the user (the operator) of the commercial printing company when the operator manages the printing operations outsourced by the customer.

The operator accesses a Web user interface of the print server 12 via the World Wide Web (www) browser to search for a print job, to start printing, to stop printing, to delete the print job, to manage the printing system 2, and the like. The print server 12 is an example of a printing management device. The print server 12 is configured to receive the print jobs of the outsourced printing operations from the user client 1 and send the print jobs to an appropriate one of the printer devices 13 to print out the documents. The print server 12 is also configured to graphically display an operational status of each of the printer devices 13 in real time. The printer device 13 generates print images from the print jobs to print the print images on predetermined sheets based on the control of the print server 12.

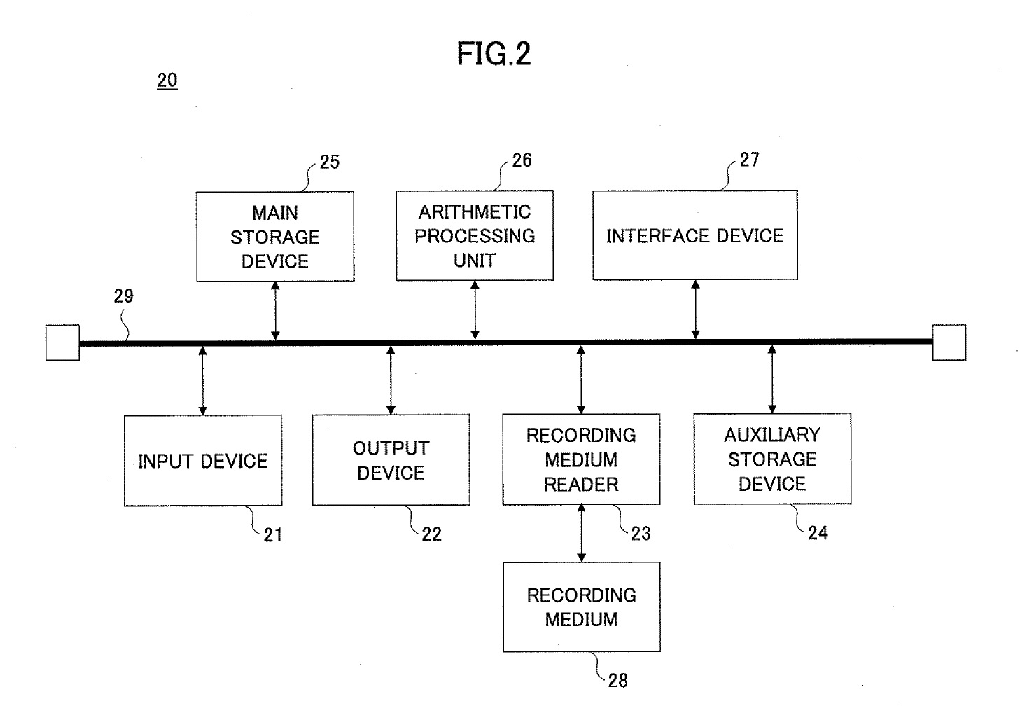

For example, the print server 12 may be realized by a personal computer (PC) having a hardware configuration illustrated in FIG. 2. FIG. 2 is a hardware configuration diagram illustrating an example of the PC. The PC 20 includes an input device 21, an output device 22, a recording medium reader 23, an auxiliary storage device 24, a main storage device 25, an arithmetic processing unit 26, and an interface device 27, which are connected one another via a bus 29.

The input device 21 may be a keyboard, a mouse or the like. The input device 21 is utilized for inputting various signals. The output device 22 may be a display device or the like. The output device 22 is utilized for displaying various windows, data and the like. The interface device 27 may be a modem, a LAN card or the like. The interface device 27 is utilized for connecting the PC 20 to the network 14.

A printing management program installed on the print server 12 corresponds to at least one of various programs that control the PC 20. The printing management program may be provided by the distribution of a recording medium 28 or being downloaded via the network 14 or the like.

Various types of recording media may be used as the recording medium 28. Examples of the recording medium 28 include a recording medium such as a CD-ROM, a flexible disk and a magneto-optical disk on which information is optically, electrically or magnetically recorded; or a semiconductor memory such as a ROM or a flash memory on which information is electrically recorded.

When the recording medium 28 storing the printing management program is placed in the recording medium reader 23, the design program is installed in the auxiliary storage device 24 from the recording medium 28 via the recording medium reader 23. The printing management program downloaded via the network 14 or the like is installed in the auxiliary storage device 24 via the interface device 27.

The auxiliary storage device 24 stores the installed printing management program, desired files, data and the like. The main storage device 25 stores the printing management program retrieved from the auxiliary storage device 24 at the startup of the printing management program. The arithmetic processing unit 26 realizes various types of processes described later in accordance with the printing management program stored in the main storage device 25.

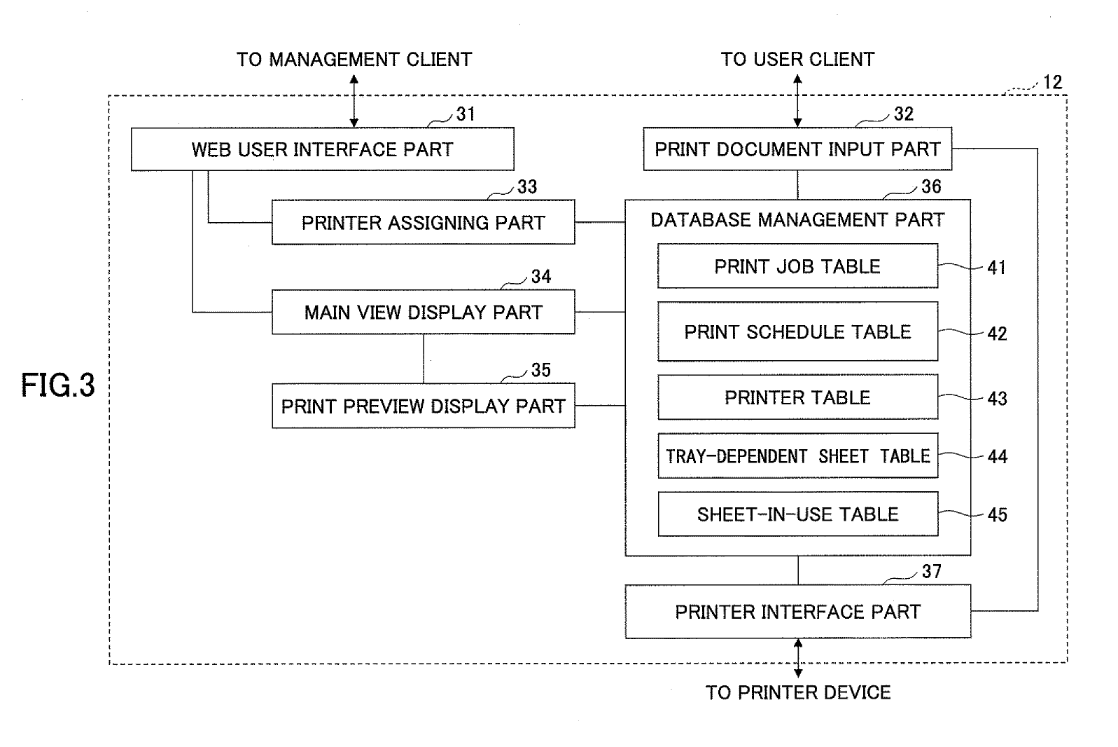

The print server 12 may be realized by process blocks illustrated in FIG. 3. FIG. 3 is a process block diagram illustrating an example of a print server. The print server 12 installs the printing management program. The print server 12 executes the printing management program to implement functions of a web user interface part 31, a print document input part 32, a printer assigning part 33, a main view display part 34, a print preview display part 35, a database management part 36 and a printer interface part 37.

The web user interface part 31 is configured to control the communication with the management client 11. The web user interface part 31 is configured to receive from the management client 11 requests to search for a document such as a print target document, to start printing, to stop printing, to delete the document and to manage the printing system 2 and the like.

The print document input part 32 receives a print job including a job ticket of print target documents and print data from the user client 1. The print document input part 32 registers information on the received print jobs in the database management part 36. The print jobs registered in the database management part 36 are scheduled in the printer device 13 such that the printer device 13 executes the scheduled print jobs to perform printing.

The database management part 36, for example, includes a print job table 41, a print schedule table 42, a printer table 43, a tray-dependent sheet table 44 and a sheet-in-use table 45. The database management part 36 receives a request from the print document input part 32, the printer assigning part 33, the main view display part 34, the printer interface part 37 or the like to write data in a corresponding one of the tables of the database management part 36.

The print job table 41 is configured to retain information on the print jobs received from the user client 1. Note that details of the print job table 41 are described later. The print schedule table 42 is configured to retain information on the expected printer device 13 ready to execute the print jobs and a status of each of the print jobs. Note that details of the print job table 42 are described later.

The printer table 43 is configured to retain information on the connections of the printer devices 13 such as IP addresses, statuses of the printer devices 13 and information on whether sheet information is received from the printer devices 13. The tray-dependent sheet table 44 is configured to retain information on the paper feed tray 13 of the printer device 13 and information (a current value) on a size of the currently loaded sheets in the paper feed tray 13. Note that details of the tray-dependent sheet table 44 are described later.

The sheet-in-use table 45 is configured to retain information on sheets registered by the operator. The sheet-in-use table 45 retains information on the sheets owned by the operator to be actually used for printing operations. Details of the sheet-in-use table 45 are described later.

The printer interface part 37 is configured to control communications with the printer devices 13. The printer interface part 37 searches for a subsequently predetermined print job by referring the print schedule table 42 every time a report that the preceding print job has been completed has been received from the corresponding printer device 13. Next, on finding the subsequently predetermined print job, the printer interface part 37 acquires details of the print job from the print job table 41. The printer interface part 37 sends the print job in the print document input part 32 to the corresponding printer device 13 based on the details of the acquired print job.

The printer interface part 37 is further configured to receive status information on the printer device 13 at predetermined intervals from each of the printer devices 13. If the printer interface part 37 acknowledges one or more of the printer devices 13 have changed their status, the printer interface part 37 requests the database management part 36 to replace the status information including status information of the corresponding printer device 13 retained by the printer table 43 or the tray-dependent sheet table 44 with the new status information (i.e., changed status information).

The printer interface part 37 figures out a status of the print job based on the status of the corresponding printer device 13, and requests the database management part 36 to update the status of each of the print jobs retained by the print schedule table 42.

The printer assigning part 33 is configured to be responsible for assignment of the print jobs to the printer devices 13. The printer assigning part 33 assigns a print job to a corresponding one of the printer devices 13 based on an attribute of the print job and an attribute of each of the printer devices 13. If the printer assigning part 33 is capable of acquiring information (detailed information) on the sheets from the printer devices 13, the printer assigning part 33 assigns the print job to the printer devices 13 based on whether the detailed information on the sheets currently loaded on the paper feed tray of the printer device 13 matches detailed information on the sheets specified in the print job.

The main view display part 34 is configured to retrieve necessary items from each of the tables of the database management part 36 to display the later-described main view screen. The print preview display part 35 is configured to retrieve necessary items from the print job table 41 to display a print job preview screen. Note that details of the print job preview screen are described later. Note also that the operator may change the sheets into other ones by operating the sheet-in-use table 45 in the print job preview screen.

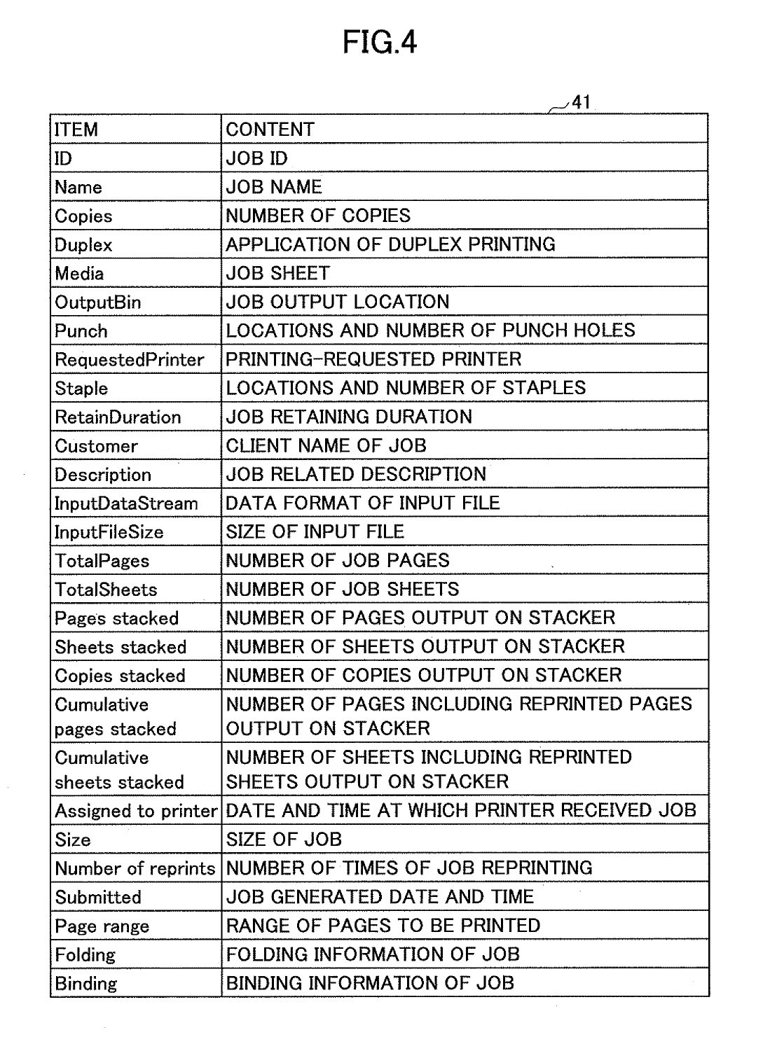

FIG. 4 is a configuration diagram illustrating an example of the print job table 41. The print job table 41 includes items associated with following corresponding contents, which are a job ID, a job name, the number of copies, application of duplex printing, a job sheet, a job output location, locations and number of punch holes, a printing-requested printer, locations and number of staples, job retaining duration, a client name of job, a job related description, a data format of an input file, a size of the input file, the number of job pages, the number of job sheets, the number of pages output on a stacker, the number of sheets output on the stacker, the number of copies output on the stacker, the number of pages including reprinted pages output on the stacker, the number of sheets including the reprinted sheets output on the stacker, date and time at which the printer received job, a size of a job, the number of times of job reprinting, job generated date and time, a range of pages to be printed, folding information of the job and binding information of the job.

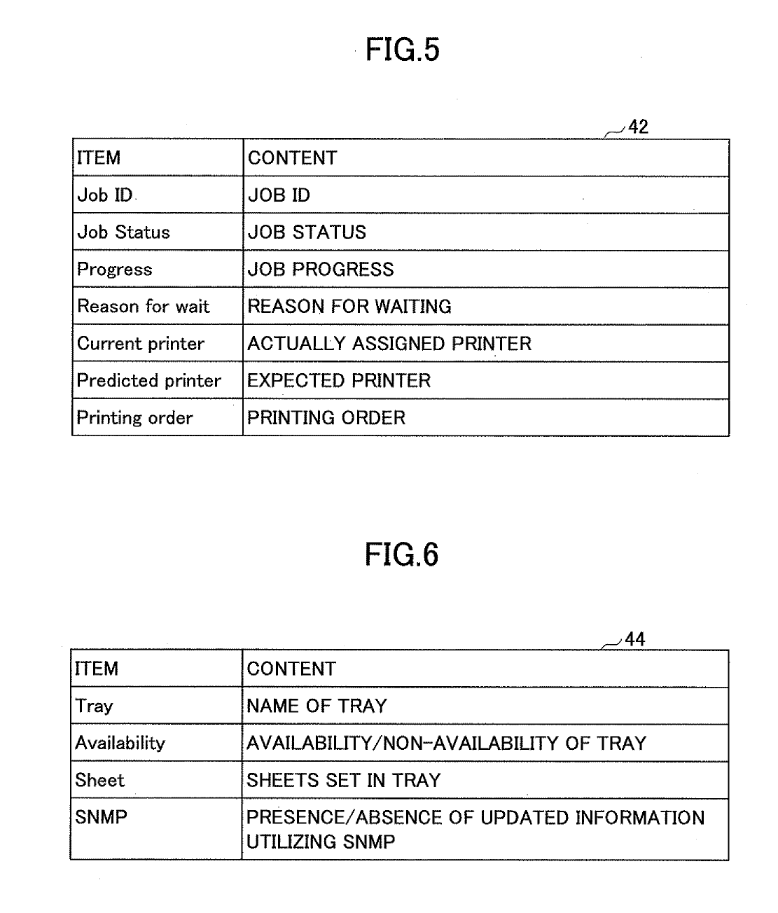

FIG. 5 is a configuration diagram illustrating an example of the print schedule table 42. The print schedule table 42 includes items associated with following corresponding contents, which are a job ID, a job status, a job progress, a reason for waiting, an actually assigned printer, an expected printer, a printing order and a printing-requested printer.

FIG. 6 is a configuration diagram illustrating an example of the tray-dependent sheet table 44. The tray-dependent sheet table 44 includes items associated with the following corresponding contents, which are a name of the tray, availability or non-availability of the tray, sheets set the in tray and presence or absence of updated information utilizing a simple network management protocol (SNMP).

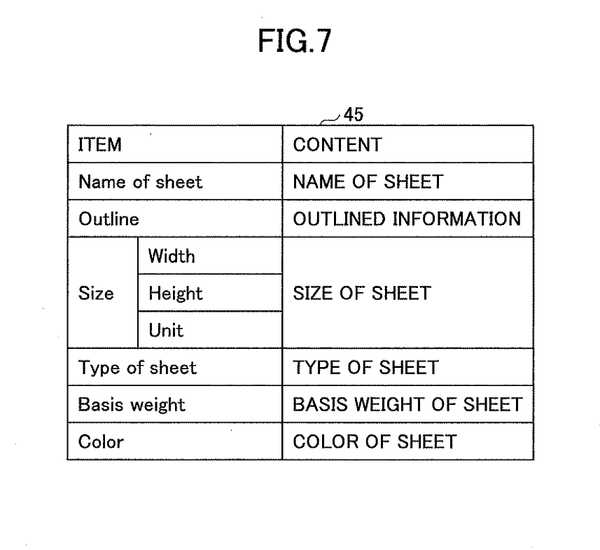

FIG. 7 is a configuration diagram illustrating an example of the sheet-in-use table 45. The sheet-in-use table includes items associated with following corresponding contents, which include a name of the sheets, outline information, a size of the sheets, a type of the sheets, basis weight of the sheets and a color of the sheets. Additional items other than those described above may be added to the sheet-in-use table 45 for reflecting them in the print preview. Examples of the additional items include items associated with whether a surface or a rear-surface of the sheet has particular surface treatment such as “printed”, “punched”, “surface texture” and “coated”, or items associated with properties of the sheet such as “the content of used paper”, “the opacity of the sheet” and the like.

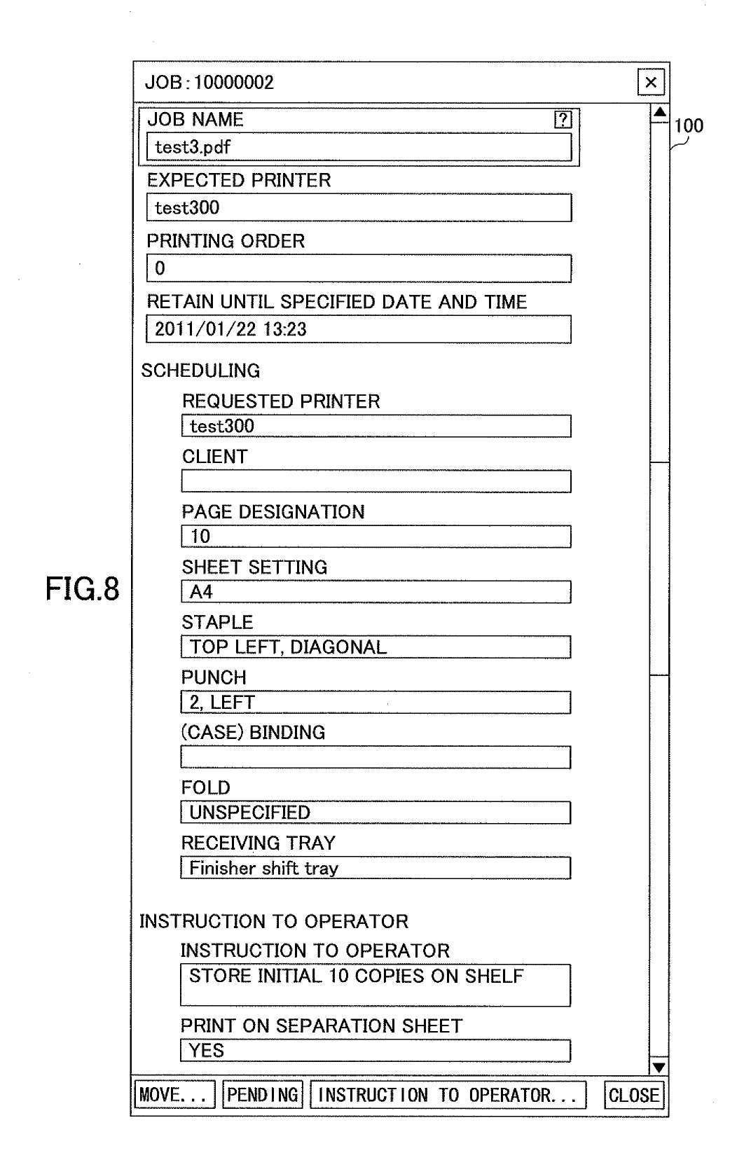

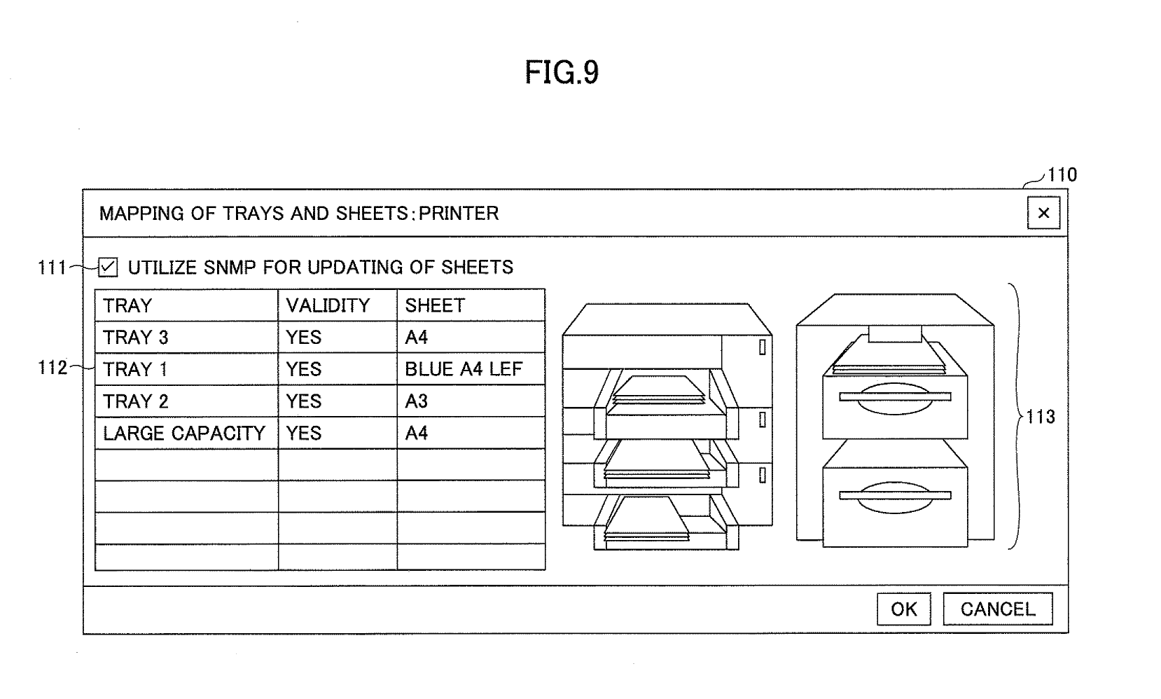

FIG. 8 is an image diagram illustrating an example of a print job information display screen 100. The print job table 41 illustrated in FIG. 4 and the print schedule table 42 illustrated in FIG. 5 are created based on the print job information received from the user client 1. FIG. 9 is an image diagram illustrating an example of a tray-dependent sheet information screen 110. The tray-dependent sheet information screen 110 illustrated in FIG. 9 includes a check box (a selecting part) 111 for switching information displayed based on whether information on sheets placed in each of the paper feed trays (i.e., the tray-dependent sheet information) is acquired from the printer device 13, a table 112 for indicating a name of each of the paper feed trays, the valid or invalid paper feed tray, and types of the sheets placed in each of the paper feed trays and an image 113 representing the sheets set in each of the paper feed trays. FIG. 9 illustrates an example in which the tray-dependent sheet information is acquired from the printer device 13 utilizing SNMP.

The tray-dependent sheet information maybe acquired from the printer device 13 utilizing SNMP at predetermined intervals or at a time when the print job is received. The tray-dependent sheet information screen 110 illustrated in FIG. 9 is displayed utilizing the tray-dependent sheet table illustrated in FIG. 6.

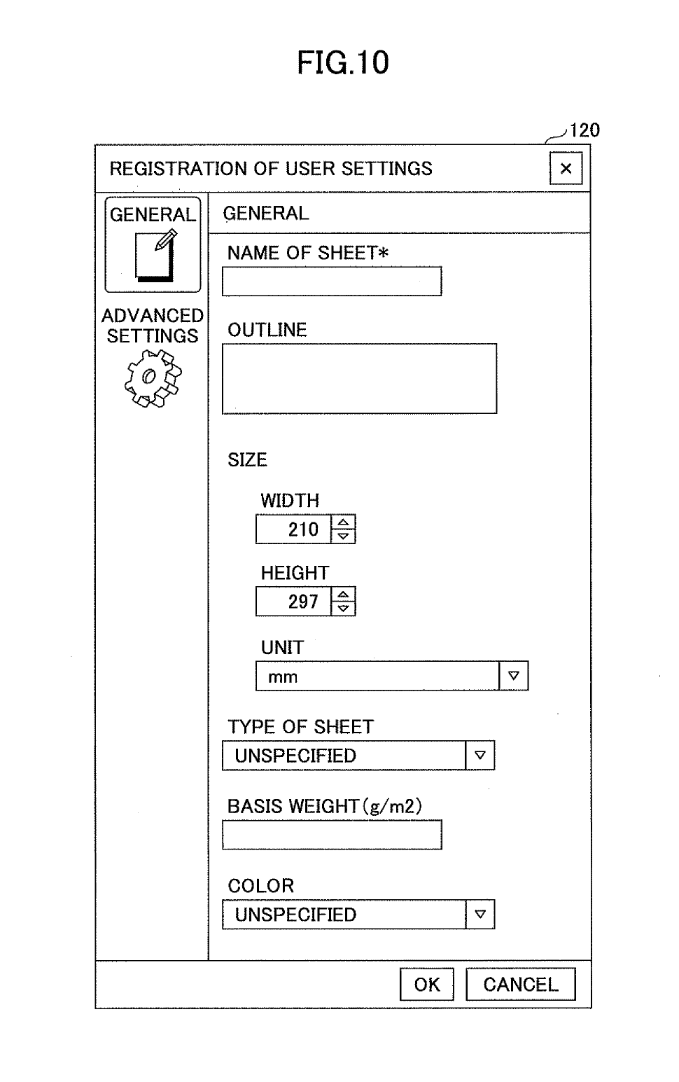

FIG. 10 is an image diagram illustrating an example of a sheet requirement registering screen 120. The sheet-in-use table 45 illustrated in FIG. 7 is registered by the operator or the like via the sheet requirement registering screen 120 illustrated in FIG. 10. The sheet requirement registering screen 120 illustrated in FIG. 10 registers a name of the sheets, outline information, a type of the sheet, the basis weight of the sheets and a color of the sheets as the sheet information. Similar to the sheet-in-use table 45 in FIG. 7, additional items may added to the sheet requirement registering screen 120, such as items associated with whether a surface or a rear-surface of the sheet has particular surface treatment such as “printed”, “punched”, “surface texture” and “coated”, or items associated with properties of the sheet such as “the content of used paper”, “the opacity of the sheet” and the like.

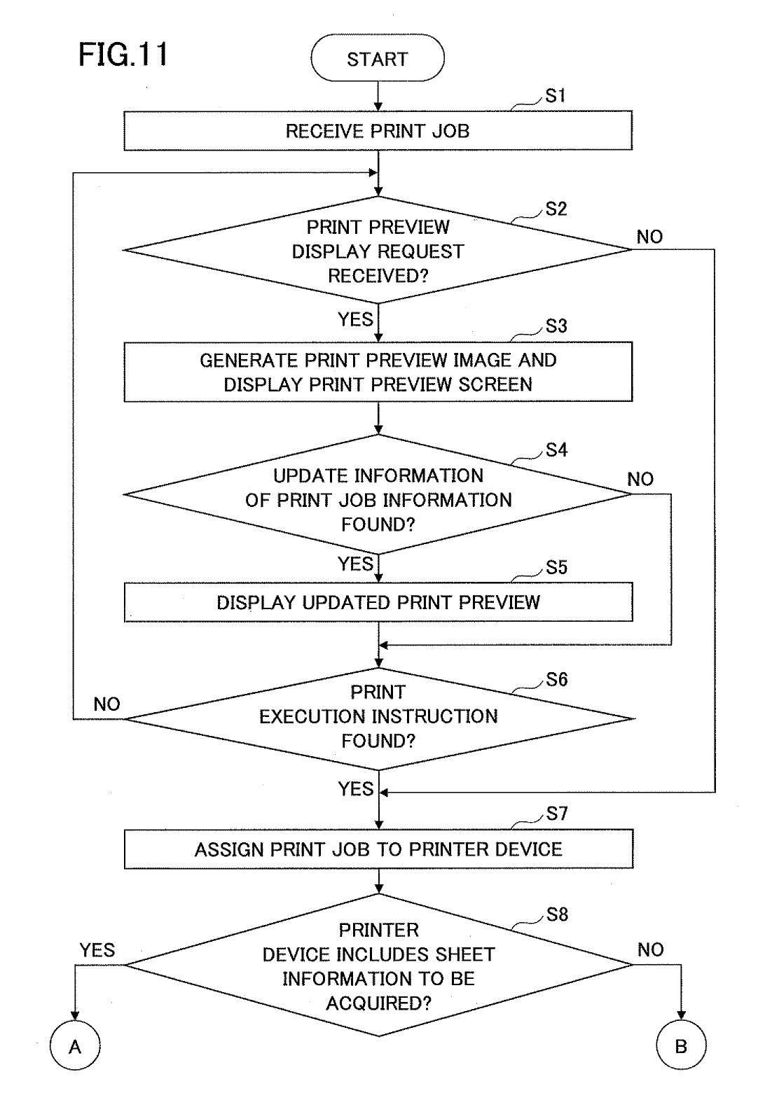

FIGS. 11 to 13 are flowcharts each illustrating an example of the printing procedure accompanied with the print preview display. In step S1, the print document input part 32 receives a print job, for example, from the user client 1.

In step S2, the print preview display part 35 determines whether a request for displaying a print preview (i.e., a print preview display request) has been received. For example, if the web user interface part 31 has not received the print preview display request from the management client 11, the print preview display part 35 determines that the print preview display request has not been received. Further, if the web user interface part 31 has received the print preview display request from the management client 11, the print preview display part 35 determines that there is the print preview display request.

If the print preview display part 35 determines that there is no print preview display request (“NO” in step S2), the printer assigning part 33 proceeds with the later-described process in step S7. Note that if the print preview display part 35 determines that there is a print preview display request (“YES” in step S2), the print preview display part 35 retrieves necessary items from the print job table 41, generates a print preview image and displays the print preview screen in step S3. If the print preview screen displayed in step S3 matches the sheet information registered in the sheet-in-use table 45, the print preview screen is displayed based on the print job information regardless of the printing capability of the printer device 13. The sheet-in-use table 45 registers information on the sheets that are utilized by the printer devices 13 to perform printing operations. Accordingly, the print preview screen that matches the sheet information registered in the sheet-in-use table 45 may eventually provide (result in) an output result as expected from the print preview screen.

The print preview display part 35 determines whether there is update information of the print job information by referring to the print job table 41 in step S4. The update information of the print job information includes update information of the paper feed trays and update information of the sheets. If the update information of the print job information is found (“YES” in step S4), the print preview display part 35 retrieves necessary items from the print job table 41, generates the updated print preview image and displays the updated print preview screen in step S5.

Further, after the print preview screen is updated, the web user interface part 31 determines whether there is an instruction to execute printing (i.e., a print execution instruction) in step S6. Note that even if there is no update information of the print job information (“NO” in step S4), the web user interface part 31 still determines whether there is a print execution instruction in step S6.

In step S6, if the web user interface part 31 determines that there is no print execution instruction (“NO” in step S6), the print preview display part 35 repeatedly carries out the process in step S2. In step S6, if the web user interface part 31 determines that there is a print execution instruction (“YES” in step S6), the printer assigning part 33 proceeds with the process in step S7.

In step S7, the printer assigning part 33 assigns the print job to a corresponding one of the printer devices 13. In step S8, the printer assigning part 33 refers to the tray-dependent sheet table 44 corresponding to the printer device 13, to which the printer assigning part 33 has assigned the print job in step S7, and determines whether the printer device 13 includes the sheet information to be acquired based on the items associated with the contents having presence/absence of updated information updated by utilizing SNMP.

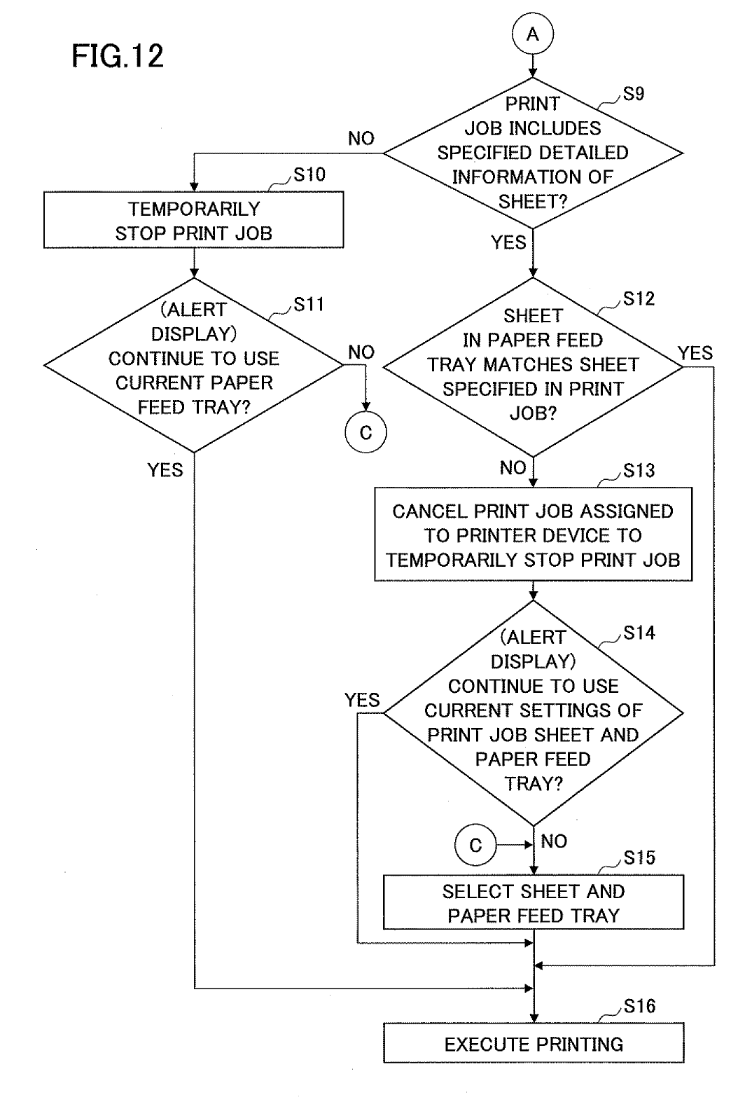

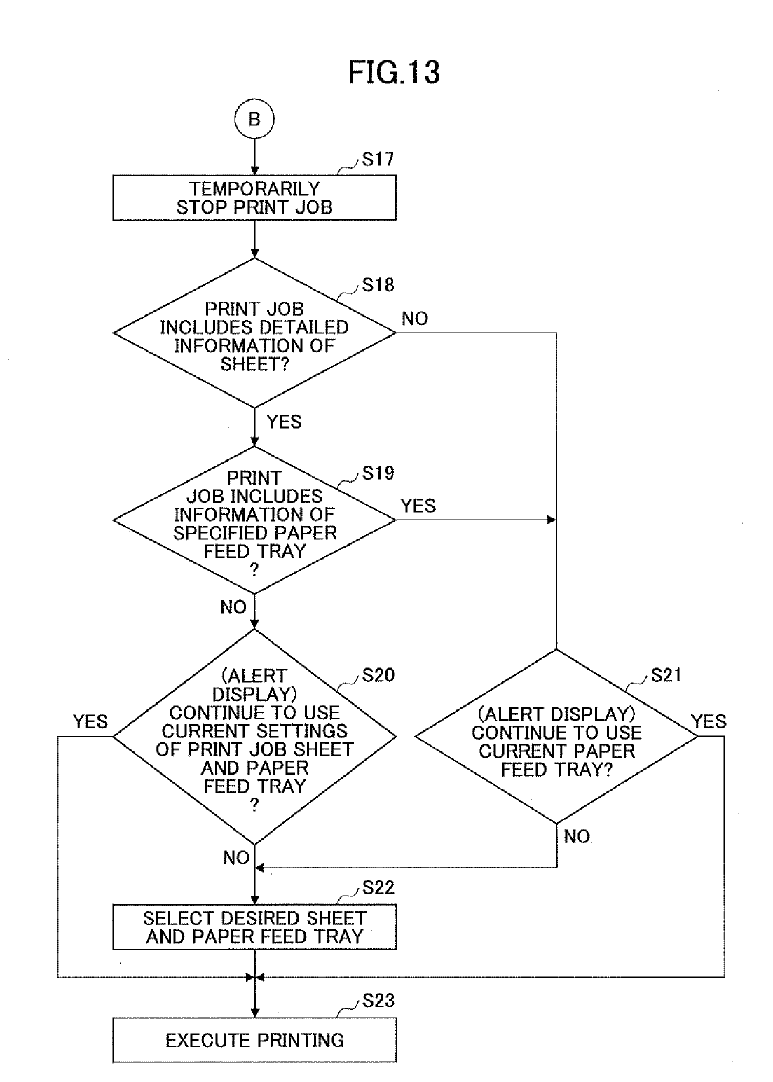

If the printer assigning part 33 determines that the printer device 13 includes the sheet information to be acquired (“YES” in step S8), the printer assigning part 33 proceeds with a process in step S9 illustrated in FIG. 12. If, on the other hand, the printer assigning part 33 determines that the printer device 13 includes no sheet information to be acquired (“NO” in step S8), the printer assigning part 33 proceeds with a process in step S17 illustrated in FIG. 13.

Note that if the acquired sheet information of the printer device 13 does not include sufficient information to compare the acquired sheet information with the sheet information specified in the print job, the printer assigning part 33 determines that the printer device 13 includes no sheet information to be acquired, despite the fact that the sheet information of the printer device 13 has been acquired. For example, there is a case where sizes of the sheets (e.g., A3, A4, B4 and B5) and types of the sheets (e.g., Plain, Thick and Thin) may be settable but colors of the sheets may not be settable. In this case, although A4 plain blue sheets and A4 plain white sheets are set in different paper feed trays, the printer device 13 may not identify such a difference between the blue and white sheets set in the different paper feed trays.

In step S9 (see FIG. 12), the printer assigning part 33 determines whether the print job includes specified detailed information of the sheet by referring to the print job table 41. If the detailed information of the sheet is not specified in the print job (“NO” in step S9), the printer assigning part 33 temporarily stops printing of the print job in step S10. The reason for temporarily stopping printing of the print job in step S10 is that the features of the sheets displayed in the print preview in step S3 are unlikely to match the features of the sheets actually set in the paper feed tray of the printer device 13, due to the fact that the detailed information of the sheet is not specified in the print job.

In step S11, the main view display part 34 displays an alert to invite the operator to check whether to use the current paper feed tray as the paper feed tray to which sheets are to be supplied. Details of the alert display screen, via which the operator checks whether to use the current paper feed tray as the paper feed tray to which sheets are to be supplied, are described later.

If the operator determines that the current paper feed tray is continuously used as the paper feed tray to which sheets are to be supplied, the operator may specify (select) the “continue current settings” to continuously use the current paper feed tray via the alert display screen. If the operator determines that the current paper feed tray is changed into another one, the operator may request to specify (select) another paper feed tray via the alert display screen. When the operator specifies (selects) the “continue current settings” in order to continue to use the current settings, the printer assigning part 33 executes the printing of the print job in step S16.

Note that if the specification of the paper feed tray is requested, the main view display part 34 presents the print job information display screen 100 illustrated in FIG. 8 to the operator to invite him or her to change the sheets set in the paper feed tray or select a desired one of the paper feed trays in step S15. Then, the printer assigning part 33 executes the printing of the print job in step S16.

If the detailed information of the sheet is specified in the print job (“YES” in step S9), the printer assigning part 33 determines whether the sheets set in the paper feed tray of the printer 13 match the sheets specified in the print job in step S12.

If the sheets set in the paper feed tray of the printer 13 match the sheets specified in the print job, the printer assigning part 33 cancels the print job assigned to the printer 13 and temporarily stops printing of the print job in step S13. The reason for cancelling the assignment of the print job to the printer 13 and temporarily stopping printing of the print job in step S13 is that the sheets displayed in the print preview in step S3 do not match the sheets actually set in the paper feed tray of the printer device 13.

Note that the sheets may be previewed when the print job is temporarily stopped in steps S10 and S13. Further, if the print preview display request is not received in step S2, the print preview of the sheets may be displayed in a mandatory manner regardless of the presence or absence of the print preview display request.

In step S14, the main view display part 34 displays an alert to the operator to indicate a difference between the sheets (i.e., the physical sheets) set in the paper-feed tray and the sheets displayed in the print preview. The main view display part 34 displays the alert to invite the operator to check the sheets specified in the print job and the physical sheet loaded on the paper feed tray. Details of the alert display screen indicating to the operator a difference between the sheets set in the paper-feed tray and the sheets displayed in the print preview are described later.

If the operator determines that the current paper feed tray and the current sheet are continuously used, the operator may specify (select) the “continue current settings” to continuously use the current paper feed tray and the current sheet via the alert display screen. If, on the other hand, the operator determines that the current paper feed tray and the current sheet are changed into other ones, the operator may specify (select) a desired one of the paper feed trays and a desired one of the sheets via the alert display screen. When the operator selects the “continue current settings”, the printer assigning part 33 executes the printing of the print job in step S16.

Note that if a request to specify the paper feed tray and a request to change the sheet (specify the sheet) of the print job are received, the main view display part 34 presents the print job information display screen 100 illustrated in FIG. 8 to the operator to invite him or her to change the sheets set in the paper feed tray or select a desired one of the paper feed trays in step S15. Then, the printer assigning part 33 executes the printing of the print job in step S16. If the sheets set in the paper feed tray of the printer 13 match the sheets specified in the print job in step S12, the printer assigning part 33 executes the printing of the print job in step S16.

In step S17, the printer assigning part 33 temporarily stops printing of the print job. The reason for allowing the printer assigning part 33 to temporarily stop printing of the print job in step S17 is that the features of the sheets displayed in the print preview in step S3 may not match the features of the sheets actually set in the paper feed tray of the printer device 13, due to the fact that the printer assigning part 33 fails to acquire part of the sheet information from the printer device 13.

In step S18 (see FIG. 13), the printer assigning part 33 determines whether the print job includes specified detailed information of the sheet by referring to the print job table 41. If the detailed information of the sheet is specified in the print job (“YES” in step S18), the printer assigning part 33 determines whether the paper feed tray is specified in the print job in step S19.

If the paper feed tray is not specified in the print job (“NO” in step S19), the main view display part 34 displays an alert display screen to indicate the difference between the sheets set in the paper-feed tray and the sheets displayed in the print preview to the operator, in a similar manner as in step S14. When the operator selects the “continue current settings” in the alert display screen, the printer assigning part 33 executes the printing of the print job in step S23.

Note that if a request to specify the paper feed tray and a request to change the sheet of the print job are received, the main view display part 34 presents the print job information display screen 100 illustrated in FIG. 8 to the operator to invite him or her to change the sheet into a desired one set in the paper feed tray or select a desired one of the paper feed trays in step S22. Then, the printer assigning part 33 executes the printing of the print job in step S23.

In step S18, if the detailed information of the sheet is specified in the print job (“YES” in step S18), the printer assigning part 33 displays an alert display screen to invite the operator to check whether to continuously use the current paper feed tray in step S20 in a similar manner as step S11. When the operator selects the “continue current settings” in the alert display screen, the printer assigning part 33 executes the printing of the print job in step S23.

Note that if the specification of the paper feed tray is requested, the main view display part 34 presents the print job information display screen 100 illustrated in FIG. 8 to the operator to invite him or her to change the sheets set in the paper feed tray or select a desired one of the paper feed trays instep S22. Then, the printer assigning part 33 executes the printing of the print job in step S23.

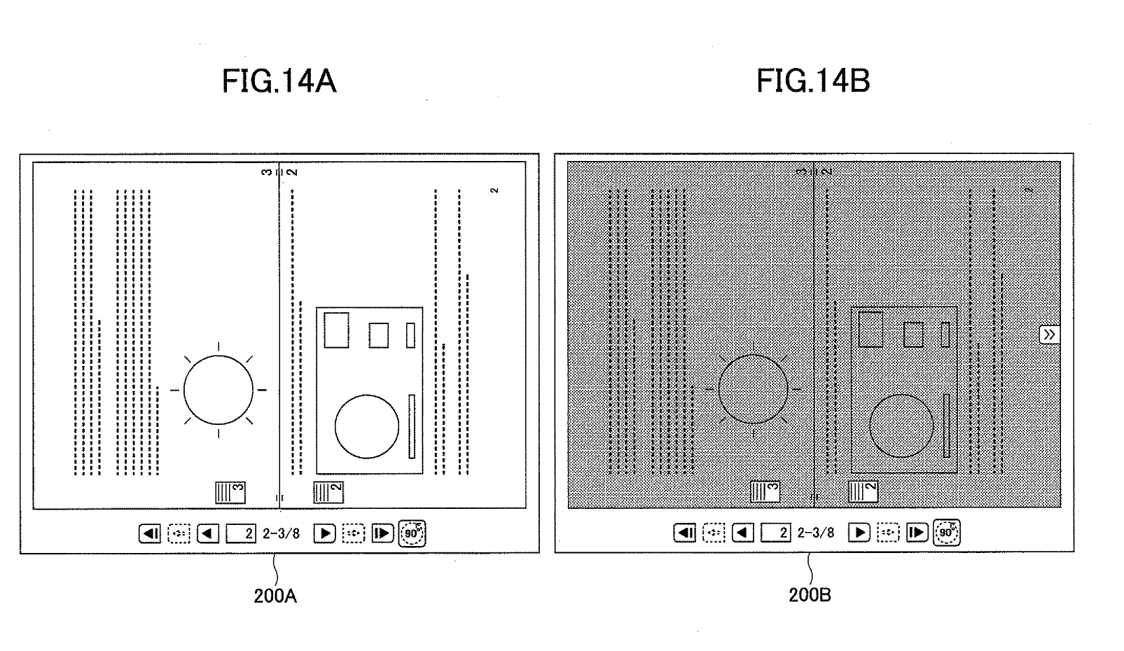

FIGS. 14A and 14B are image diagrams illustrating an example of the print preview screen. The print preview reflects the detailed information on the sheets specified in the print job. Note that print preview screen 200B in FIG. 14B illustrates an example in which the sheet of the print preview screen 200A is changes into a colored sheet. Further, the print preview screens 200A or 200B may further include an editing screen to edit the information of the print job. In this case, editing contents of the information of the print job may instantly be reflected in the print preview screen by the executing of the process in step S4 illustrated in FIG. 11.

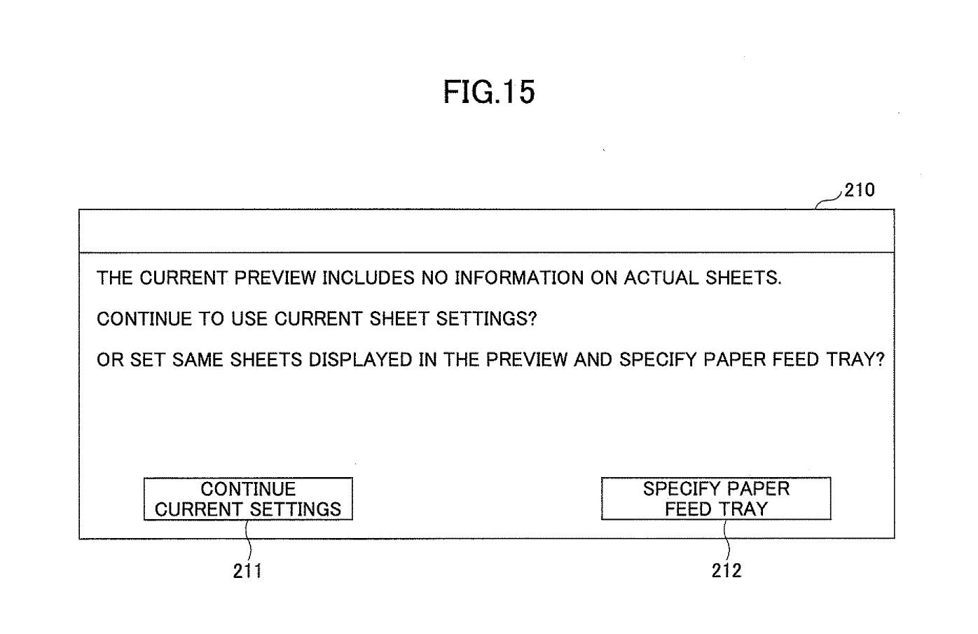

FIG. 15 is an image diagram illustrating an example of an alert display screen indicating to the operator a difference between the sheets set in the paper-feed tray and the sheets displayed in the print preview. The alert display screen 210 illustrated in FIG. 15 is configured to display an alert to indicate to the operator the difference between the sheets (i.e., the physical sheets) set in the paper-feed tray and the sheets displayed in the print preview. Note that the alert display screen 210 illustrated in FIG. 15 displays a “continue current settings” button 211 selected by the operator to continuously use the current settings and a “specify paper feed tray” button 212 selected by the operator to specify the paper feed tray and the sheet of the print job.

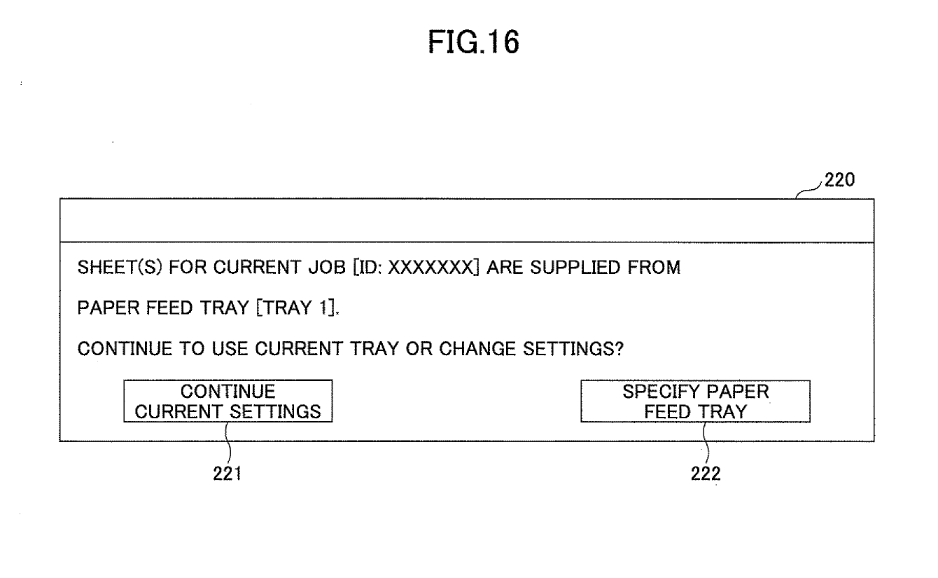

FIG. 16 is an image diagram illustrating an example of an alert display screen 220 inviting the operator to check the paper-feed tray to which sheets are to be supplied. The alert display screen 220 illustrated in FIG. 16 displays an alert to invite the operator to check the paper-feed tray to which sheets are to be supplied. Note that the alert display screen 220 illustrated in FIG. 16 displays a “continue current settings” button 221 selected by the operator to continuously use the current settings and a “specify paper feed tray” button 222 selected by the operator to specify the paper feed tray.

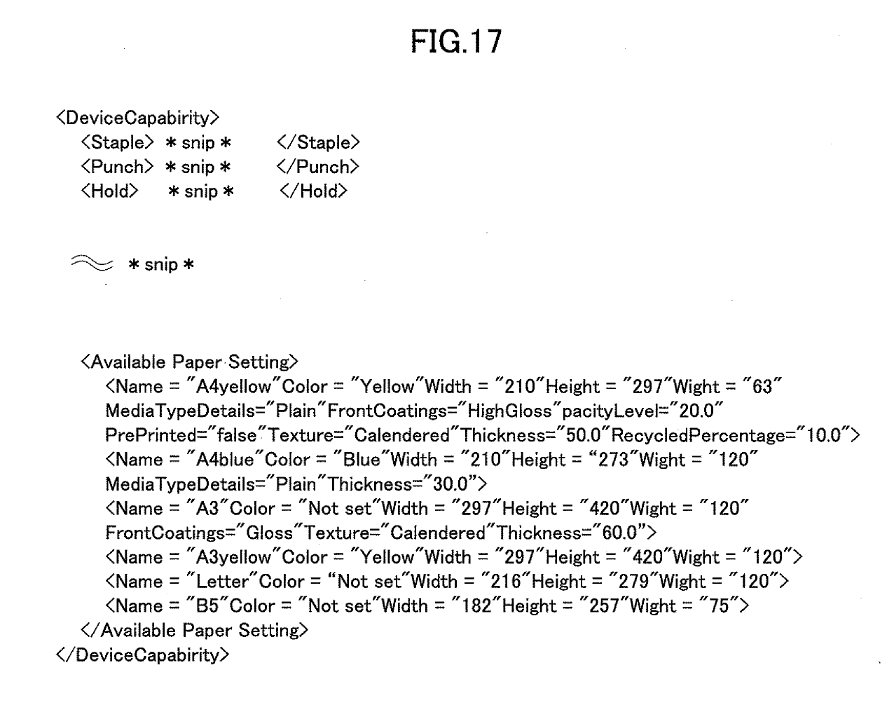

FIG. 17 is a data structure diagram illustrating an example of data of the printer device from which the printability (device capability) information is acquired. The device capability represents settings of the sheets utilized in the printer device. Note that the device capability information may be shared between the user client 1 and the management client 11.

### First Embodiment

Procedures of printing processes illustrated in the flowcharts of FIGS. 11 to 13 are described with reference to specific examples of settings of the sheets of the print job and settings of the sheets set in the paper feed tray below.

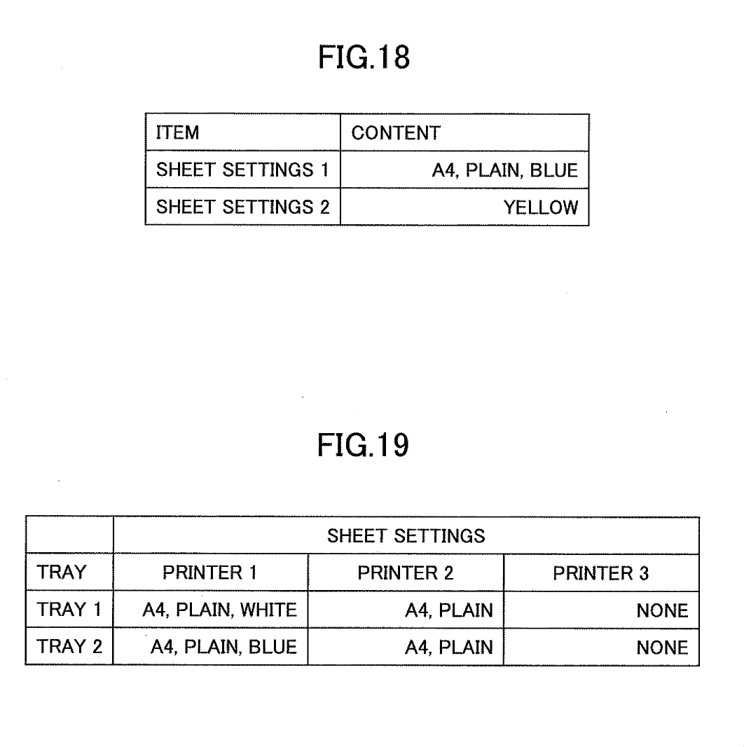

FIG. 18 is a configuration diagram illustrating an example of the settings of the sheets of the print job.

As illustrated in FIG. 18, the “SHEET SETTINGS 1” is specified as “A4, PLAIN, BLUE”. The “SHEET SETTINGS 2” is specified as “YELLOW”.

FIG. 19 is a configuration diagram illustrating an example of information on the sheets in the paper-feed trays acquired from the printer device. In FIG. 19, the “PRINTER 1” is assumed to have all the information on the sheets loaded on the paper feed trays. More specifically, the information “A4, PLAIN, WHITE” on the sheets loaded on the “TRAY 1” of the “PRINTER 1” and the information “A4, PLAIN, BLUE” on the sheets loaded on the “TRAY 2” of the “PRINTER 1” are acquired from the printer device.

Note that the “PRINTER 2” is assumed to have failed to acquire part of the information on the sheets loaded on the paper feed trays. More specifically, the information “A4, PLAIN” on the sheets loaded on the “TRAY 1” of the “PRINTER 2” and the information “A4, PLAIN” on the sheets loaded on the “TRAY 2” of the “PRINTER 1” are acquired from the printer device. That is, the “PRINTER 2” has failed to acquire color information on the sheets loaded on the paper feed trays.

Note that the “PRINTER 3” is assumed to have acquired no information on the sheets loaded on the paper feed trays. Specifically, the “PRINTER 3” has acquired no information on the sheets loaded on the paper feed trays.

Initially, the following case is described in which the “SHEET SETTINGS 1” is specified as the settings of the sheets contained in the print job, and the printer device 13 is specified as the “PRINTER 1”. Illustrations of steps S1 to S7 are omitted. In step S8, the printer assigning part 33 determines that the “PRINTER 1” corresponds to the printer device 13 from which the information on the sheets is acquired, and proceeds with the procedure illustrated in the flowchart of FIG. 12.

In step S9, the printer assigning part 33 determines that the detailed information on the sheets is specified in the print job based on contents of the “SHEET SETTINGS 1”, and proceeds with the process in step S12. In step S12, the printer assigning part 33 determines that the sheets set in the “TRAY 2” of the “PRINTER 1” match the contents of the “SHEET SETTINGS 1” specified in the print job, the printer assigning part 33 executes the printing of the print job in step S16.

Next, the following case is described in which the “SHEET SETTINGS 2” is specified as the settings of the sheets contained in the print job, and the printer device 13 is specified as the “PRINTER 1”. Illustrations of steps S1 to S7 are omitted. In step S8, the printer assigning part 33 determines that the “PRINTER 1” corresponds to the printer device 13 from which the information on the sheets is acquired, and proceeds with the procedure illustrated in the flowchart of FIG. 12.

In step S9, the printer assigning part 33 determines that the detailed information on the sheets is specified in the print job based on contents of the “SHEET SETTINGS 2”, and proceeds with the process in step S12. In step S12, the printer assigning part 33 determines that the sheets set in the “TRAY 2” of the “PRINTER 1” do not match the contents of the “SHEET SETTINGS 2” specified in the print job, the printer assigning part 33 cancels the assignment of the printer device 13 to the “PRINTER 1” and temporarily stops printing of the print job in step S13.

In step S14, the main view display part 34 displays an alert to indicate to the operator the difference between the sheets (i.e., the physical sheets) set in the paper-feed tray of the “PRINTER 1” and the sheets displayed in the print preview. The main view display part 34 displays the alert to invite the operator to check the sheet specified in the print job and the physical sheet loaded on the paper feed tray of the “PRINTER 1”.

Next, the following case is described in which the “SHEET SETTINGS 1” is specified as the settings of the sheets contained in the print job, and the printer device 13 is specified as the “PRINTER 2”. Illustrations of steps S1 to S7 are omitted. In step S8, the printer assigning part 33 determines that the “PRINTER 2” corresponds to the printer device 13 from which part of the information on the sheets will not be acquired, and proceeds with the procedure illustrated in the flowchart of FIG. 13.

In step S17, the printer assigning part 33 temporarily stops printing of the print job. In step S18, the printer assigning part 33 determines that the detailed information on the sheets is specified in the print job based on the contents of the “SHEET SETTINGS 1”, and proceeds with the process in step S19. In step S19, the printer assigning part 33 determines that the print job includes no information on the specification of a particular paper feed tray.

In step S20, the main view display part 34 displays an alert to indicate to the operator the difference between the sheets (i.e., the physical sheets) set in the paper-feed tray of the “PRINTER 2” and the sheets displayed in the print preview. The main view display part 34 displays the alert to invite the operator to check the sheet specified in the print job and the physical sheets set in the paper feed tray of the “PRINTER 2”.

Next, the following case is described in which the “SHEET SETTINGS 2” is specified as the settings of the sheets contained in the print job, and the printer device 13 is specified as the “PRINTER 2”. Illustrations of steps S1 to S7 are omitted. In step S8, the printer assigning part 33 determines that the “PRINTER 2” corresponds to the printer device 13 from which part of the information on the sheets will not be acquired, and proceeds with the procedure illustrated in the flowchart of FIG. 13.

In step S17, the printer assigning part 33 temporarily stops printing of the print job. In step S18, the printer assigning part 33 determines that the detailed information on the sheets is specified in the print job based on the contents of the “SHEET SETTINGS 1”, and proceeds with the process in step S19. In step S19, the printer assigning part 33 determines that the print job includes no information on the specification of a particular paper feed tray.

In step S20, the main view display part 34 displays an alert to indicate to the operator the difference between the sheets (i.e., the physical sheets) set in the paper-feed tray of the “PRINTER 2” and the sheets displayed in the print preview. The main view display part 34 displays the alert to invite the operator to check the sheet specified in the print job and the physical sheets set in the paper feed tray of the “PRINTER 2”.

Next, the following case is described in which the “SHEET SETTINGS 1” is specified as the settings of the sheets contained in the print job, and the printer device 13 is specified as the “PRINTER 3”. Illustrations of steps S1 to S7 are omitted. In step S8, the printer assigning part 33 determines that the “PRINTER 3” corresponds to the printer device 13 from which none of the information on the sheets will be acquired, and proceeds with the procedure illustrated in the flowchart of FIG. 13.

In step S17, the printer assigning part 33 temporarily stops printing of the print job. In step S18, the printer assigning part 33 determines that the detailed information on the sheets is specified in the print job based on the contents of the “SHEET SETTINGS 1”, and proceeds with the process in step S19. In step S19, the printer assigning part 33 determines that the print job includes no information on the specification of a particular paper feed tray.

In step S20, the main view display part 34 displays an alert to indicate to the operator the difference between the sheets (i.e., the physical sheets) set in the paper-feed tray of the “PRINTER 3” and the sheets displayed in the print preview. The main view display part 34 displays the alert to invite the operator to check the sheet specified in the print job and the physical sheets set in the paper feed tray of the “PRINTER 3”.

Next, the following case is described in which the “SHEET SETTINGS 2” is specified as the settings of the sheets contained in the print job, and the printer device 13 is specified as the “PRINTER 3”. Illustrations of steps S1 to S7 are omitted. In step S8, the printer assigning part 33 determines that the “PRINTER 3” corresponds to the printer device 13 from which none of the information on the sheets will be acquired, and proceeds with the procedure illustrated in the flowchart of FIG. 13.

In step S17, the printer assigning part 33 temporarily stops printing of the print job. In step S18, the printer assigning part 33 determines that the detailed information on the sheets is specified in the print job based on the contents of the “SHEET SETTINGS 2”, and proceeds with the process in step S19. In step S19, the printer assigning part 33 determines that the print job includes no information on the specification of a particular paper feed tray.

In step S20, the main view display part 34 displays an alert to indicate to the operator the difference between the sheets (i.e., the physical sheets) set in the paper-feed tray of the “PRINTER 3” and the sheets displayed in the print preview. The main view display part 34 displays the alert to invite the operator to check the sheet specified in the print job and the physical sheets set in the paper feed tray of the “PRINTER 3”.

In this embodiment, the operator will be reported on the expected difference between the sheets displayed in the print preview and the physical sheets to be actually printed out regardless of acquiring or not acquiring the information on the sheets from the printer device 13.

Specifically, the embodiment includes the following features when the print preview is displayed. According to the embodiment, the operator is reported on the expected difference between the sheets displayed as the print preview (i.e., imaginary sheets) and the sheets actually utilized (i.e., the sheets set in the paper feed tray of the printer device 13), it may be easy to obtain the output result that matches the print preview.

The invention is not limited to the embodiments disclosed above, and various modifications and alterations may be made within the scope of the inventions described in the claims.

Note that the registration receiving unit described in the claim corresponds to the sheet-in-use table 45. The print job receiving unit described in the claim corresponds to the print job table 41. The print preview display unit described in the claim corresponds to the print preview display part 35. The determining unit described in the claim corresponds to the printer assigning part 33. The alert display unit described in the claim corresponds to the main view display part 34. The printing management device described in the claim corresponds to the print server 12.

According to one embodiment, there is disclosed a non-transitory computer-readable recording medium that includes a printing management program. The printing management program, when processed by a processor, causes a computer to function as: a registration receiving unit configured to receive registration of a sheet requirement of first sheets, the registered sheet requirement of the first sheets being specified in a print job; a print job receiving unit configured to receive the print job from a previous process within a printing process; and a print preview display unit configured to reflect the registered sheet requirement of the first sheets in the received print job to display a print preview.

In this embodiment, the processor further causes the computer to function as: a determining unit configured to retrieve information on second sheets set in one of paper feed units of an image forming apparatus, to which the print job is assigned, from a paper feed unit-dependent sheet table configured to record information on sheets set in the paper feed units to determine whether the registered requirement of the first sheets reflected in the print job matches the information on the second sheets set in the paper feed tray retrieved from the paper feed unit-dependent sheet table; and an alert display unit configured to display an alert when the registered requirement of the first sheets reflected in the received print job does not match the information on the second sheets set in the paper feed tray retrieved from the paper feed unit-dependent sheet table.

In this embodiment, the print preview display unit reflects the registered sheet requirement in the print job received from the previous process to display the print preview regardless of a result determined by the determining unit.

In this embodiment, the determining unit temporarily stops printing of the print job when the registered requirement of the first sheets reflected in the received print job does not match the information on the second sheets set in the paper feed tray retrieved from the paper feed unit-dependent sheet table.

In this embodiment, the alert display unit displays the alert when at least a part of the information on the second sheets set in the paper feed tray is not recorded in the paper feed unit-dependent sheet table.

According to another embodiment, there is provided a printing management apparatus that includes a registration receiving unit configured to receive registration of a sheet requirement of first sheets, the sheet requirement of the first sheets being specified in a print job; a print job receiving unit configured to receive the print job from a previous process within a printing process; and a print preview display unit configured to reflect the registered sheet requirement of the first sheets in the received print job to display a print preview.

According to another embodiment, there is provided a printing management method executed by a computer. The printing management method includes: receiving registration of a sheet requirement of first sheets, the sheet requirement of the first sheets being specified in a print job; receiving the print job from a previous process within a printing process; and reflecting the registered sheet requirement of the first sheets in the received print job to display a print preview.

According to another embodiment, there is provided a printing system that includes a printing management device and an image forming apparatus. In the printing system, the printing management device includes: a registration receiving unit configured to receive registration of a sheet requirement of first sheets, the sheet requirement of the first sheets being specified in a print job; a print job receiving unit configured to receive the print job from a previous process within a printing process; and a print preview display unit configured to reflect the registered sheet requirement of the first sheets in the received print job to display a print preview.

According to another embodiment, there is provided a printing system that includes a non-transitory computer-readable recording medium having a printing management program and an image forming apparatus performing printing of a print job.

Note that any elements, expressions, or combinations, as appropriate, of the aforementioned constituting elements and so forth applied to a method, device, system, computer program, recording medium, and the like are all effective as and encompassed by the embodiments of the present invention.

The embodiments discussed above may provide the printing management device, the printing management method, the printing system and the recording medium storing the printing management program that are capable of acquiring the output result that matches the print preview.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority or inferiority of the invention. Although the embodiment of the present invention has been described in detail, it should be understood that various changes, substitutions, and alterations could be made hereto without departing from the spirit and scope of the invention.

This patent application is based on Japanese Priority Patent Application No. 2011-045637 filed on Mar. 2, 2011, the entire contents of which are hereby incorporated herein by reference.

What is claimed is:

1. A non-transitory computer-readable recording medium comprising a printing management program, which, when processed by a processor, causes a computer to function as:
a registration receiving unit configured to receive registration of a sheet requirement of first sheets, the registered sheet requirement of the first sheets being specified in a print job;
a print job receiving unit configured to receive the print job from a previous process within a printing process; and
a print preview display unit configured to reflect the registered sheet requirement of the first sheets in the received print job to display a print preview.

2. The non-transitory computer-readable recording medium as claimed in claim 1, wherein the processor further causes the computer to function as:
a determining unit configured to retrieve information on second sheets set in one of paper feed units of an image forming apparatus, to which the print job is assigned, from a paper feed unit-dependent sheet table configured to record information on sheets set in the paper feed units to determine whether the registered requirement of the first sheets reflected in the print job matches the information on the second sheets set in the paper feed tray retrieved from the paper feed unit-dependent sheet table; and
an alert display unit configured to display an alert when the registered requirement of the first sheets reflected in the received print job does not match the information on the second sheets set in the paper feed tray retrieved from the paper feed unit-dependent sheet table.

3. The non-transitory computer-readable recording medium as claimed in claim 2, wherein
the print preview display unit reflects the registered sheet requirement in the print job received from the previous process to display the print preview regardless of a result determined by the determining unit.

4. The non-transitory computer-readable recording medium as claimed in claim 2, wherein
the determining unit temporarily stops printing of the print job when the registered requirement of the first sheets reflected in the received print job does not match the information on the second sheets set in the paper feed tray retrieved from the paper feed unit-dependent sheet table.

5. The non-transitory computer-readable recording medium as claimed in claim 2, wherein
the alert display unit displays the alert when at least a part of the information on the second sheets set in the paper feed tray is not recorded in the paper feed unit-dependent sheet table.

6. A printing management apparatus comprising:
a registration receiving unit configured to receive registration of a sheet requirement of first sheets, the sheet requirement of the first sheets being specified in a print job;
a print job receiving unit configured to receive the print job from a previous process within a printing process; and
a print preview display unit configured to reflect the registered sheet requirement of the first sheets in the received print job to display a print preview.

7. A printing management method executed by a computer, the printing management method comprising:
receiving registration of a sheet requirement of first sheets, the sheet requirement of the first sheets being specified in a print job;
receiving the print job from a previous process within a printing process; and
reflecting the registered sheet requirement of the first sheets in the received print job to display a print preview.

8. A printing system comprising a printing management device and an image forming apparatus, wherein
the printing management device includes:
a registration receiving unit configured to receive registration of a sheet requirement of first sheets, the sheet requirement of the first sheets being specified in a print job;
a print job receiving unit configured to receive the print job from a previous process within a printing process; and
a print preview display unit configured to reflect the registered sheet requirement of the first sheets in the received print job to display a print preview.

9. A printing system comprising the non-transitory computer-readable recording medium having the printing management program as claimed in claim 1 and an image forming apparatus performing printing of the print job.
